(19) United States
(12) Patent Application Publication
(10) Pub. No.: US 2014/0129424 A1
(43) Pub. Date: May 8, 2014

(54) TRANSACTION COST MIRROR

(71) Applicant: BANK OF AMERICA CORPORATION, Charlotte, NC (US)

(72) Inventors: Matthew D. Murphy, Charlotte, NC (US); Elbert Lee Whitler, Webster Groves, MO (US)

(73) Assignee: BANK OF AMERICA CORPORATION, Charlotte, NC (US)

(21) Appl. No.: 13/668,293

(22) Filed: Nov. 4, 2012

(51) Int. Cl. G06Q 20/22

(52) U.S. Cl. CPC G06Q 20/22
USPC 705/39

(57) ABSTRACT

Methods and apparatus may include a calculator for use in determination of a cost of acceptance associated with a purchase and/or group of purchases. The calculator may determine one or more surcharge attributes based on input provided by a transaction participant and one or more transaction fee rules. Apparatus and methods may include a device for dynamically adjusting the transaction cost based on a change in a surcharge attribute. Apparatus and methods may include determining a transaction cost by obtaining authorization services from one interchange provider and final settlement with a second interchange provider. Apparatus and methods may implement a secondary market for trading bundled transactions associated with specified surcharge attributes.

### FIELD OF TECHNOLOGY

Aspects of the disclosure relate to providing apparatus and methods for determining a transaction cost in connection with a transaction between two or more transaction participants.

### BACKGROUND

In a transaction, a customer (the “customer”) may purchase from a merchant (“the merchant”) goods or services (“the product”) using credit. The credit may be extended to the customer by an issuing bank (the “issuer”). The issuer may authorize the transaction before extending credit to customer. The merchant presents the transaction to an acquiring bank (the “acquirer”). The acquirer pays the merchant for (and thus “acquires”) the product. A transaction processing network in communication with the issuer and the acquirer settles the transaction between the issuer and the acquirer. The transaction processing network may collect transaction processing network fees from the issuer and the acquirer in connection with the settlement.

Settling the transaction may include the transaction network receiving a plurality of transactions from the acquirer. Each transaction may be embodied in a transaction record. Each of the plurality of transactions may comprise an amount authorized by the issuer. The transaction network may debit an account of the issuer. The debit may correspond to the amount authorized by the issuer. The transaction network may credit an account of the acquirer the amount authorized.

Settlement may include a transfer of funds between two or more transaction participants. The transfer may be a “book transfer,” an inter-bank transfer or any suitable transfer between the transaction participants. A settlement network may transfer the funds between transaction participants. Illustrative settlement networks may include the Federal Reserve Wire Network (“Fedwire”) and other suitable settlement networks that are well known to those of ordinary skill in the art. The settlement network may be any suitable network linking one or more accounts of transaction participants.

One transaction participant may impose a transaction cost upon another transaction participant for participating in the transaction. The transaction cost may be referred to as “interchange.” Interchange may be a fixed fee for the transaction or a percentage of the transaction. Interchange may be a fixed fee and/or a percentage of the transaction.

Interchange flows from the acquirer, through the transaction processing network, to the issuer. For example, the issuer may transfer to the acquirer an amount net interchange. The issuer typically uses interchange to cover costs of acquiring credit card customers, servicing credit card accounts, providing incentives to retain customers, mitigating fraud, covering customer credit risk, group compensation and other expenses.

The acquirer may deduct a transaction cost from the amount that the acquirer pays the merchant in exchange for the product. The transaction cost may cover the acquirer's transaction processing network fee, interchange, and other expenses. The transaction cost may include a profit for the acquirer.

FIG. 1 shows typical credit card transaction settlement flow 100. Flow 100 involves transaction participants such as the merchant, the customer, and transaction service providers that are identified below. At step 1, the merchant provides information, relating to a proposed transaction between the merchant and a customer, to a transaction authorization and clearance provider. The transaction authorization and clearance provider may be a transaction processing network. The transaction authorization and clearance provider may provide transaction authorization and clearance information to the merchant. The transaction authorization and clearance information may include authorization for the transaction to proceed.

At step 2, the merchant provides $100 in product to the customer. The customer pays with a credit card. At step 3, the issuer transmits to the customer a statement showing the purchase price of ($100.00) due. The issuer collects the purchase price amount, along with interest and fees if appropriate, from the customer. At step 4, the issuer routes the purchase price amount of ($100.00) through the transaction processing network to the acquirer. At step 5, the acquirer partially reimburses the merchant for the purchase price amount. In the example shown in FIG. 1, the partial reimbursement is $98.00. The difference between the reimbursement amount ($98.00) and the purchase price amount ($100.00) is a two dollar ($2.00) transaction cost.

At step 6, the acquirer pays an interchange amount ($1.50), via the transaction processing network, to the issuer. At step 7, both the acquirer and the issuer pay a transaction processing network fee ($0.07 for acquirer and $0.05 for the issuer) to the transaction processing network.

TABLE 1
Net positions, by participant, based on
settlement flow 100 (shown in FIG. 1).

| Participant | Net ($) |
|---|---|
| Issuer | 1.45 |
| Acquirer | 0.43 |
| Transaction processing network | 0.12 |
| Merchant | −2.00 |
| Customer | 0 |

In settlement 100 (shown in FIG. 1), the transaction cost is based on an exemplary merchant discount rate of 2%. The $1.50 interchange is based on an exemplary interchange rate of 1.5%. The sum of the transaction processing network fees ($0.07 and $0.05) is based on a total exemplary transaction processing network fee rate of 0.12%.

Transaction processing networks and transaction processing network services are offered under trademarks known to those of ordinary skill in the art. Transaction processing networks may set interchange rates. Issuers may set interchange rates. Interchange rates often depend for each transaction processing network on merchant type and size, transaction processing method, transaction volume and other factors.

A merchant may impose a surcharge for accepting credit card payments, establish minimum or maximum purchase price amounts or refuse to accept selected credit cards. The surcharge may allow the merchant to recover some or all of the transaction cost charged to the merchant by other transaction participants. The surcharge imposed by the merchant may be determined and/or limited based on a total transaction cost associated with the transaction. The total transaction cost may include interchange, the merchant discount and network fees.

It would be desirable, therefore, to provide apparatus and methods for determining a transaction cost associated with a transaction.

Imposing the surcharge may adversely impact payment options available to the customer. A customer may wish to avoid the added expense of the surcharge. Although alternative payment options, such as cash, may not be subject to the surcharge, the customer may not wish to carry a sufficient amount of cash to pay for daily purchases.

Carrying cash may be undesirable due to a fear that the cash may be lost or stolen. Furthermore, some customer's may not have access to the sufficient amount of cash needed to pay for daily purchases. Some customers may wish to pay for purchases using credit to obtain rewards or other benefits associated with a credit payment. However, credit payments may be subject to the surcharge. Thus, imposition of the surcharge may result in the customer using an unattractive payment method.

It would be desirable, therefore, to provide apparatus and methods for encouraging merchants to provide customers with attractive payment options.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a prior art scenario;

FIG. 2 shows illustrative apparatus in accordance with the principles of the invention;

FIG. 3 shows an arrangement in which apparatus and methods in accordance with the principles of the invention may be used;

FIG. 4 shows illustrative information in accordance with the principles of the invention;

FIG. 5 shows illustrative information in accordance with the principles of the invention;

FIG. 6 shows an illustrative process in accordance with the principles of the invention;

FIG. 7 shows illustrative information in accordance with the principles of the invention;

FIG. 8 shows illustrative information in accordance with the principles of the invention;

FIG. 9 shows illustrative arrangement in which apparatus and methods in accordance with the principles of the invention may be used; and

FIG. 10 shows illustrative information in accordance with the principles of the invention.

### DETAILED DESCRIPTION OF THE INVENTION

Apparatus and methods for determining a transaction cost are provided. The transaction cost may be a cost associated with a transaction. The transaction cost may be associated with one or more transaction services. The transaction cost may be associated with processing the transaction. The processing may include one transaction participant providing services to another transaction participant. The transaction cost may be associated with services performed or provided on behalf of the merchant, the issuer, the acquirer, the customer or any suitable transaction participant.

For example, the transaction cost may include the interchange fee. The transaction cost may include the network fee. The transaction cost may include the fee for providing a transaction service. The transaction cost may include the fee imposed by one transaction participant on another transaction participant in connection with the transaction. Illustrative transaction services are listed in Table 2.

TABLE 2
Illustrative transaction services.
Illustrative Transaction Service

Sale of goods to customer
Authorization of customer credit
Clearance of customer credit
Notice of customer balance
Invoice of customer for bank service
Invoice of network fee
Invoice of interchange fee
Matching of acquirer and issuer
Acquisition of goods
Collection of balance from customer
Settlement of merchant account
Transfer of funds to acquirer
Debit of funds from issuer

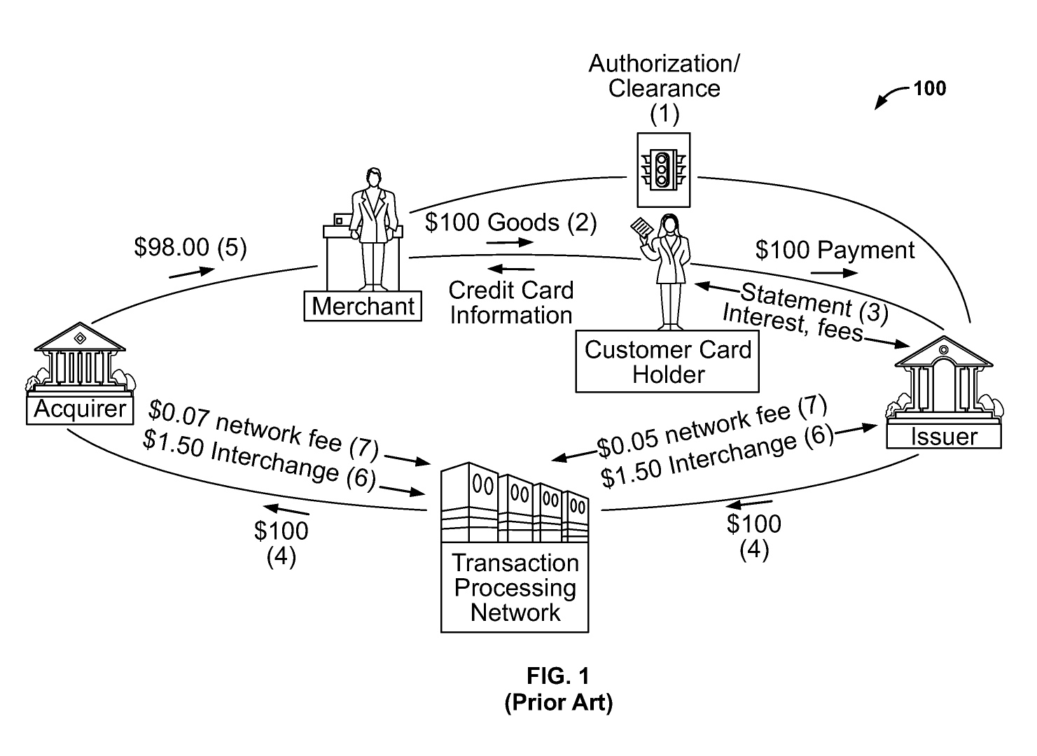

Each transaction service may be performed by a transaction participant. In some circumstances, a participant may perform more than one of the services. Each participant may charge a fee for providing the service. The fee may be charged to one or more of the other participants (as shown in FIG. 1). Thus, for each transaction, a participant may be required to pay (or collect), in sum, a “net” fee. A transaction fee rule may require that the net fee for a designated participant conform to a requirement. The rule may be imposed by a transaction participant.

Table 3 shows illustrative transaction participant types.

TABLE 3
Illustrative participant types.
Illustrative Transaction Participant Types

Merchant
Customer
Authorization service provider
Clearance service provider
Settlement service provider
Issuer
Network
Acquirer
Transaction broker

More than one participant of a given type may be available to participate in the transaction. Different participants of the same type may have advantages and/or disadvantages relative to the other participants of that type. For example, one issuer may be a member of a lending consortium while another is not a member, one transaction processing network may require payment of a relatively small interchange fee while another network may require payment of a relatively large interchange fee, and the like.

The transaction may involve an acceptance of a payment instrument by a merchant. The transaction may involve a credit, debit, prepaid, automated clearing house, or any suitable payment method involving the transfer of funds from one participant to another.

The transaction may be a transaction in any state of completion. The transaction may be a prospective transaction. The prospective transaction may include the customer presenting the payment instrument to pay for the product. The prospective transaction may include the merchant collecting payment instrument information from the customer.

The transaction may be a pending transaction. For example, a transaction may be pending prior to receiving authorization from the issuer. The transaction may be pending during a time between receiving the authorization and settlement. The transaction may be pending during a time prior to collection, by the issuer, of the purchase amount from the customer.

The transaction may be an executed transaction. Executing the transaction may include a first transaction participant passing the transaction along to a second transaction participant. An executed transaction may include a transaction that has been authorized and settled.

The payment instrument may include a credit card and/or other forms of payment instruments. Such other forms of payment instruments may include: cash, a check, a debit card, an instrument or device that includes a contactless chip, such as an ISO14443-compliant contactless chip, a smart phone, a tablet computer, a transponder or any other suitable electronic purchasing devices. Payment instruments may store data in a magnetic strip, a bar code, a silicon chip, non-volatile computer readable media or any other suitable data storage device or format. The merchant may provide a point-of-sale (“POS”) terminal that is configured to receive data from, provide data to, or exchange data with the payment instrument.

The payment instrument may be presented to the merchant by the customer as payment for the product. The transaction cost may be associated with acceptance, by the merchant, of the payment instrument as a form of payment. The transaction cost may be an acceptance cost associated with the payment instrument.

The acceptance cost may include a fee a merchant pays to other transaction participants. The fee may enable the merchant to accept a payment instrument as form of payment for a product.

The transaction may be associated with one or more transaction attributes. The transaction cost may be based on the one or more of the transaction attributes. Table 4 shows illustrative transaction attributes and associated values.

A transaction record may be generated based on transaction attributes received and/or available at a time of purchase. Each transaction record may include one or more fields. Each field may include an attribute associated with the transaction. The attribute may be represented by a value. The value may be stored in the field of the transaction record.

The transaction record may include derived attributes. Exemplary derived attributes may include surcharge sensitivity, the surcharge, or recovery amount.

Synoptic attributes may be derived by grouping individual transaction records that share one or more attributes. For example, transaction records may be grouped based on a common surcharge amount. Transaction records may be grouped based on date, merchant category code (“MCC”), number of items purchased or a credit card identifier.

For example, a synoptic attribute may be derived that correlates the surcharge amount to a purchase amount. A synoptic attribute may relate the surcharge amount to number of items sold within a geographic region or on particular date.

TABLE 4
Illustrative transaction attributes and associated values.

| Illustrative Transaction Attributes | Illustrative Associated Value |
|---|---|
| Geographic | Longitude/latitude |
| | GPS coordinates |
| | Map coordinates |
| | Elevation |
| | Depth |
| | Distance from a point |
| | Address |
| | Zip code |
| | Area code |
| | County |
| | State |
| | Country |
| | IP address |
| | Signal triangulation |
| Temporal | Seconds |
| | Minutes |
| | Hours |
| | Day |
| | Week |
| | Month |
| | Year |
| | Duration |
| Synoptic | Weather at time of |
| | transaction |
| | Stock market performance at |
| | time of transaction |
| | Political party in power at |
| | time of transaction |
| | Transaction participant |
| | credit risk |
| Transaction amount | Dollars |
| | Available credit |
| | Currency |
| | Foreign exchange rate |
| | Low value purchase |
| Number of items purchased | Number |
| | Number of distinct stock |
| | keeping units (“SKU”) |
| Merchant category code | Numerical identifier |
| | Taxation status |
| | Associated acquirer |
| Surcharge | Amount |
| | Surcharge fraction |
| | Maximum surcharge |
| | Minimum surcharge |
| | Percentage of purchase |
| | Fixed amount |
| Payment instrument identifier | Brand |
| | Rewards |
| | Transaction Network |
| | Issuer |
| | Affinity |
| Loyalty program | Rewards/point balance |
| | Membership level |
| | Duration of membership |
| | Frequency of use |
| Access Channel | Point-of-sale |
| | Automated teller machine |
| | Online portal |
| | Self-service kiosk |
| | Mobile device |
| | In person |

### Transaction Cost Recovery Compliance Calculator

Apparatus may include a compliance calculator. The calculator may include one or more non-transitory computer-readable media storing computer-executable instructions. The instructions, when executed by a processor on a computer system may determine the transaction cost offset amount.

The transaction cost offset amount (hereinafter, “offset amount”) may be an amount charged to a transaction participant. For example, the offset amount may be charged to a customer that pays for a product using a payment instrument. The offset amount may be charged to the customer by the merchant that accepts the payment instrument as a form of payment. The offset amount may correspond to a size of a surcharge imposed by the merchant.

The offset amount may be a percentage of the purchase amount. The offset amount may be a flat fee. The offset amount may be a combination of a flat fee and a percentage of the purchase amount. The offset amount may be any suitable monetary amount.

The calculator may receive a transaction record. The transaction record may be transmitted to the calculator. The transaction record may be transmitted to the calculator from the merchant. The transaction record may be transmitted to the calculator from the acquirer or any suitable transaction participant. For example, the transaction record may be a historical transaction record. The historical transaction record may correspond to a record previously executed transaction obtained from a database.

The transaction record may be manually entered into the calculator by the merchant. For example, the merchant may enter exemplary transaction attributes into the calculator.

The transaction record may correspond to a non-executed or a non-executable (herein after “sample transaction record”). The sample transaction record may be created to obtain an estimate of the transaction cost associated with future transaction records that include one or more attributes of the sample transaction record. The merchant may anticipate that a future transaction record may include attributes similar to the sample transaction record.

The calculator may determine the transaction cost based on a content of the transaction record. The content of the transaction record may correspond to one or more transaction attributes included in the transaction record.

Based on the content of the transaction record, the calculator may determine the transaction cost associated with a processing of the transaction record. Processing may include one or more of authorization, settlement, transmitting the record over a transaction network or any suitable transaction service.

In a preferred embodiment, the calculator determines surcharge parameters for the merchant. The surcharge may be an amount charged to customers paying with a credit card. The surcharge may offset the transaction cost charged to the merchant.

For example, based on the content of the transaction record, the calculator may determine a maximum recovery amount associated with the transaction record. The maximum recovery amount may limit the amount that may be recovered from the customer. The maximum recovery amount may be less than the transaction cost. The maximum recovery amount may be set unilaterally by a transaction participant. The maximum recovery amount may be set contractually by an agreement between two or more transaction participants. The maximum recovery amount may be set by any suitable party such as a government or government agency.

The calculator may be configured to compare the transaction cost to the maximum recovery amount. If the transaction cost exceeds the maximum recovery amount, the calculator may set the offset amount equal to the maximum recovery amount. The calculator may limit the offset amount to an amount no greater than the maximum recovery amount.

If the transaction cost is less than or equal to the maximum offset amount, the calculator may set the offset amount equal to the transaction cost. For example, the calculator may limit the offset amount to an amount that is no greater than the transaction cost that is charged to the merchant. Such a limitation on the offset amount may prevent the merchant for making a profit on a surcharge imposed on customers. The limitation limits the offset amount to recovery of the merchants transaction cost.

The calculator may include a display. For example, the calculator may be used by a cardholder to determine the offset amount. The customer may wish to verify that they are being surcharged an offset amount that complies with the transaction fee rules or government regulations. The offset amount may be displayed on a screen of a mobile device of the customer.

The calculator may display the determined offset amount. The displayed offset amount may correspond to the surcharge imposed by the merchant. The displayed surcharge may correspond to the maximum surcharge that may be imposed by the merchant. A transaction participant, such as the merchant, may decide to impose a surcharge that corresponds to less than the displayed offset amount.

The content of the transaction record may include a transaction attribute. The content of the transaction record may include a plurality of transaction attributes. The plurality of transaction attributes may include any suitable attribute. Exemplary transaction attributes are listed above in Table 4. The calculator may determine the maximum offset amount based on one or more of the plurality of transaction attributes.

The calculator may determine the transaction cost based on one or more of the plurality of transaction attributes. For example, at least one of the plurality of transaction attributes may correspond to a payment instrument product. A transaction processing network may define a transaction cost that is associated with the payment instrument product when the payment instrument is used at a merchant location. When the payment instrument product is used to make a purchase at the merchant location, the transaction cost associated with the payment instrument product and the merchant location may be charged to the merchant.

The calculator may receive a plurality of transaction attributes. The calculator may determine the transaction cost based on the plurality of transaction attributes. For example, the calculator may determine the transaction cost associated with the merchant location and payment instrument product.

The merchant may enter one or more transaction attributes. The transaction attributes may correspond to a range of purchase amounts, a specific payment instrument or any suitable transaction attribute. The transaction attributes may exemplify a transaction or range of transactions that may be executed at a future time by the merchant. The merchant may wish to determine the transaction cost and/or offset amount for transactions that include the entered transaction attributes.

One of the plurality of transaction attributes may correspond to an issuer associated with a payment instrument. For example, an issuer may negotiate with a transaction processing network to define a special transaction cost associated with payment instruments offered by the issuer. Each time a merchant transmits, to the transaction processing network, a transaction that includes an attribute corresponding to the payment instrument associated with the issuer, the special transaction cost may be applied to the transaction.

The calculator may determine the transaction cost based on an identity of the issuer. Based on the determined transaction cost, the merchant may determine a surcharge. The size of the surcharge or surcharge amount may correspond to the offset amount. The surcharge may be imposed on customers that pay for purchases using the payment instrument associated with the issuer. The surcharge imposed by the merchant may be based on the special transaction cost associated with the payment instrument offered by the issuer.

One of the plurality of transaction attributes may correspond to a payment instrument brand. For example, the issuer may offer payment instruments that are associated with one or more transaction networks. Each payment instrument offered by the issuer may be “branded” with a logo or insignia of the transaction network associated with the payment instrument. The branded payment instrument may be subject to a transaction cost defined by the transaction network associated with the payment instrument. The merchant may apply a surcharge to the branded payment instrument. The surcharge may be based on the transaction cost defined by the transaction network associated with the branded payment instrument.

At least one of the plurality of transaction attributes may correspond to the issuer associated with the payment instrument brand. The transaction cost may be determined based on the issuer and transaction network associated with the payment instrument.

As a further example, the issuer and/or transaction network may enter into an agreement with a vendor. The agreement may be an affinity agreement. The agreement may include a rewards program associated with a payment instrument. The rewards program may be associated with a product or service offered by the vendor. The affinity agreement may be associated with a transaction cost. The calculator may determine the transaction cost associated with the affinity agreement.

The calculator may determine the offset amount based on the transaction cost associated with the affinity agreement. The merchant may apply a surcharge to the payment instrument associated with the affinity agreement. The size of the surcharge may correspond to the offset amount.

The plurality of transaction attributes may include a first transaction attribute. The first transaction attribute may correspond to a first payment instrument. The plurality of transaction attributes may include a second transaction attribute. The second transaction attribute may correspond to a second payment instrument. The calculator may determine the offset amount based on the offset amount associated with the second payment instrument. The calculator may determine the offset amount based on the offset amount associated with the first payment instrument.

For example, the merchant may accept a first or a second payment instruments to pay for a purchase. The first payment instrument may be associated with a rule that forbids the merchant from applying a surcharge to the first payment instrument that is greater than the surcharge applied to the second payment instrument. The surcharge associated with the second payment instrument may limit the maximum recovery amount associated with the first payment instrument.

At least one of the plurality of transaction attributes may correspond to a performance metric quantity. The performance metric quantity may measure a level of performance. The performance may correspond to a performance of any suitable transaction participant. Exemplary performance metric quantities may include a transaction volume, revenue, gross/net profit, number of items sold or any suitable indicator of profitability.

For example, imposing the surcharge may affect a profitability of the merchant. As a result of imposing the surcharge, customers may choose to shop at other merchants or pay for purchases using alternative payment methods. As a result of imposing the surcharge, the merchant may experience a decrease in credit card transaction volume during a time period when the surcharge is imposed.

A plurality of performance metric quantities may reflect a change in the level of performance. The change may correspond to a difference between each of the plurality of performance metric quantities. The change may correspond to an effect on one or more of the transaction participants. The change may be an effect on a profitability of a transaction participant. The change may be identified by forming a relationship between a transaction attribute and a performance metric quantity.

For example, following a “roll out” of a surcharge, the merchant may monitor a transaction volume associated with proposed or executed transactions during a time period, such as a “holiday shopping season.” During the holiday shopping season the merchant may monitor transactions associated with a branded credit card. Performance metric quantities corresponding to a daily transaction volume may be collected by the merchant for each day during the holiday shopping season. Performance metric quantities collected during the holiday season may indicate the effect of the surcharge on daily sales volume during the holiday shopping season.

The calculator may determine the offset amount based on a set of the performance metric quantities that are not less than a performance metric threshold.

For example, calculator may receive a performance metric threshold. The performance metric threshold may correspond to a target sales volume during a time period. The calculator may determine the offset amount that, statistically, if applied to a transaction will not result in the sales volume falling below the performance metric threshold during the time period.

The calculator may include instructions for determining the maximum recovery amount based on a fee published by a transaction network. For example, a transaction network may publish an average transaction cost. The average transaction cost may correspond to a mean value of transaction costs the transaction network charges for providing transaction services to a plurality of transaction participants. The average transaction cost may correspond to a mean value of transaction costs the transaction network charges for providing transaction services associated with a plurality of payment instruments.

The calculator may receive a merchant attribute. The transaction cost may be determined based on the merchant attribute. The offset amount may be determined based on the merchant attribute.

The merchant attribute may be a transaction attribute. The merchant attribute may include transaction attribute typically included in a transaction record associated with the merchant. For example, the merchant may sell products within a price range or may only accept specific payment instruments as payment. The price range or specific payment instrument may be transaction attributes typically associated with the merchant.

For example, the transaction network may assign a first transaction cost to a first merchant. The transaction network may assign a second transaction cost to a second merchant. The first or second transaction costs may be based on one or more merchant attributes. A difference between the first or second transaction costs may be based on one or more merchant attributes.

The calculator may receive a plurality of merchant attributes. The calculator may determine the transaction cost based on the plurality of merchant attributes.

For example, the merchant may enter a merchant identifier into the calculator. The calculator may associate the merchant identifier with a plurality of merchant attributes. A database may store relationships that link the merchant identifier and transaction attributes. The merchant attributes may correspond to one or more criteria utilized by a transaction network to set a transaction cost for the merchant.

The merchant attribute may correspond to a surcharge interval, current surcharge, a merchant category code, a merchant location, a merchant transaction volume or a merchant chargeback rate. The surcharge interval may correspond to a time period during which the merchant imposes a surcharge. For example, the merchant may “turn on” a surcharge during morning hours, “turn off” the surcharge during afternoon hours and “turn on” the surcharge during evening hours.

The merchant attribute may be any suitable attribute. Exemplary merchant attributes are listed below in Table 5.

TABLE 5
Illustrative merchant attributes.
Illustrative Merchant Attributes

Merchant identifier
Type of product being sold
Category of merchandise (i.e., electronics,
beddings, clothing)
Point-of-sale location within store (i.e.,
self-checkout lane)
Average sales volume
Daily number of credit card transactions
conducted
Average transaction value
Chargeback rate
Merchant location
Merchant category code
Fraud prevention methods employed
Number of fraud allegations
Surcharge history
Surcharge interval
Merchant credit rating
Merchant profits (i.e., last quarter)

The calculator may identify, for the merchant attribute, the offset amount. The offset amount may not be greater than the transaction cost.

For example, a transaction network may charge the merchant a low transaction cost as a result of a high credit card transaction volume associated with a location of the merchant. The merchant may wish to impose a surcharge and recover at least a portion of the transaction cost. Imposing the surcharge may discourage some customers from using a credit card to pay for a purchase, and may reduce the merchant's high transaction volume. A reduction in the high transaction volume may subject the merchant to an increase in transaction costs.

The merchant may therefore wish to determine an offset amount that balances the merchant's desire for high credit card transaction volume, and allows the merchant to recover at a least a portion of the transaction cost. The calculator may determine an estimated effect, on credit card transaction volume, of charging customers a surcharge that includes the offset amount. The determination may be based on one or more performance metric quantities.

For example, the calculator may access historical credit card transaction volumes associated with an offset amount. The calculator may determine an offset amount that, statistically, will not result in the credit card transaction volume falling below a threshold volume.

The calculator may assign a weight to each of the plurality of attributes. The calculator may identify the transaction cost, based on: the plurality of attributes received by the calculator, and, the weight assigned to each attribute.

For example, in determining the transaction cost, the transaction network may assign a greater weight to a merchant location than a merchant category code (“MCC”). The merchant may obtain a lower transaction cost as a result of the location despite being associated with a MCC that corresponds to a higher transaction cost.

The calculator may assign a weight to each of the plurality of performance metric thresholds. The calculator may identify the offset amount, based on: the plurality of attributes received by the calculator, and, the weight assigned to each threshold.

For example, the weight may correspond to a percentage. The percentage may be associated with a performance metric threshold. The merchant may instruct the calculator to determine the offset amount such that given a total number of transactions, a number of transactions corresponding to a product of the total number of transactions and the percentage will statistically remain above the threshold.

Following a determination of the transaction cost, the calculator may display a weight associated with each merchant attribute used to calculate the transaction cost. For example, the merchant may enter a merchant identifier. The merchant identifier may be associated with a plurality of merchant attributes. The calculator may determine the transaction cost based on the plurality of merchant attributes. The calculator may display to the merchant the transaction cost. The calculator may display the weight associated with each of the plurality of merchant attributes.

Apparatus may include an article of manufacture comprising a non-transitory computer usable medium having computer readable program code embodied therein. The program code may, when executed by a processor, determine a transaction cost associated with a credit card transaction.

The article may receive, in connection with a credit card transaction, a transaction record. The article may receive an acquirer acquisition fee associated with the transaction record.

For example, the merchant may enter into an agreement with the acquirer. The agreement may obligate the merchant to pay the acquirer a fee for each transaction that is processed by the acquirer on behalf of the merchant. The processing of the transactions may include transmitting the transaction to a transaction network for authorization. Processing of the transactions may include submitting the transaction to a transaction network for settlement.

In addition to the fee charged by the acquirer, a transaction network may charge a fee for obtaining an authorization from the issuer. A transaction network may charge a fee for settling the transaction with the issuer.

Fees charged for transaction network services may vary based on a transaction attribute contained in the transaction record. For example, each service performed by the transaction network may be associated with a different fee amount or different fee schedule. Each payment instrument may be associated with a different fee schedule. Each transaction network may charge different fees for the same service.

A transaction participant may request one or more transaction services. Each transaction service may be associated with a different fee. The article may identify a transaction fee rule that determines the fee associated with the requested transaction service. The transaction fee rule may be defined by the merchant, the acquirer, a transaction participant or any suitable provider of the service.

The transaction fee rule may be identified based on an element of the transaction record. The element may correspond to a transaction attribute. The transaction fee rule may be based on the acquirer acquisition fee. Based on the transaction fee rule, an offset amount may be determined. A transaction participant may apply a surcharge to a transaction based on the determined offset amount.

For example, for transactions that are below a threshold amount, the merchant may set a rule that defines a maximum fee the merchant is willing to pay for acquirer services, authorization services and settlement services. The article may retrieve and/or receive the rule defined by the merchant.

The article may retrieve and/or receive the rule based on a merchant identifier entered by the merchant. The merchant identifier may be associated with transaction attributes that are, statistically, typically associated with customer purchases of the merchant's products. The merchant identifier may associate the merchant with other transaction participants such as an acquirer or transaction network.

The article may retrieve and/or receive a fee schedule issued by the merchant's acquirer. The article may determine the acquirer acquisition fee for processing a transaction that includes the transaction attributes associated with the merchant identifier.

The article may identify the transaction network and fees associated with transaction network services based on one or more rules set by the transaction processing networks. For example, a rule set by the transaction processing networks may prevent the merchant from obtaining authorization services from a first network and settlement services from a second network.

The rules set by the transaction processing networks may include restrictions on an amount of the surcharge. The amount of the surcharge may correspond to the offset amount. The rules set by the transaction processing networks may restrict the surcharge that may be applied to specific payment instruments. The rules set by the transaction processing networks may restrict the surcharge that may be imposed on a transaction based on one or more transaction attributes.

The article may identify a transaction network that provides authorization and/or settlement services for a fee that is equal to or less than a difference between the maximum fee and the acquirer acquisition fee. The article may identify the transaction network based on bids submitted by a plurality of transaction networks. The article may obtain transaction service fees from a secondary market. The secondary market may provide access to transaction processing services being resold by one or more transaction brokers.

The article may present the acquirer acquisition fee, the authorization fee and the settlement fee to the merchant. The calculator may present a listing of identified transaction networks. The calculator may present fees associated with each identified transaction network. A transaction network may be identified if is able to provide the authorization and settlement services according to the parameters of a transaction fee rule.

For example, a transaction fee rule set by the merchant may indicate that the merchant wishes to impose a surcharge on payment instrument transactions. The article may identify the surcharge. The article may identify the surcharge based on a transaction cost. Identifying the surcharge may include identifying the offset amount.

The article may identify the surcharge based on one or more transaction attributes. The article may identify the surcharge based on a plurality of performance metric quantities. The transaction attributes and/or merchant attributes may be associated with the merchant identifier. The article may identify the surcharge based on one or more performance metric thresholds.

The article may include instructions for identifying alternative transaction attributes. The alternative attributes may be attributes, that if present in a transaction record, may result in the merchant paying a smaller fee for transaction services. The article may include instructions for presenting the alternative attributes to the merchant.

The article may include instructions for accepting an entry of one or more transaction attributes from the merchant. The transaction attributes entered by the merchant or associated with the merchant identifier may not be executable. The merchant may enter the alternative attributes.

### Transaction Cost Mirror

Apparatus may include a system for determining a cost of accepting a payment instrument. The cost may be a transaction cost. The system may include one or more non-transitory computer-readable media storing computer-executable instructions. The instructions, when executed by a processor on a computer system determine the cost.

In a preferred embodiment, the system determines the transaction solely based on a merchant's surcharge behavior. The merchant's surcharge behavior may include associating a transaction with a surcharge attribute. The merchant's surcharge behavior may include any suitable method of recovering from the customer the transaction cost charged to the merchant.

The system may receive a request from a merchant. The system may receive a request from any suitable transaction participant or third party. The request may ask for a cost-quote. The cost-quote may be associated with a transaction service. The cost-quote may be associated with processing of a transaction. The request may include a transaction record. The transaction record may include one or more transaction attributes. The system may determine the cost based on one or more transaction attributes associated with the transaction record.

The transaction attribute may be a surcharge attribute. The surcharge attribute may be any suitable attribute of the surcharge.

For example, the surcharge may be associated with an offset amount, a region, a MCC and a payment instrument. Based on the surcharge attributes, the surcharge may be imposed on a purchase made within the region at the location associated with the MCC using the payment instrument.

The surcharge attribute may include a surcharge fraction. The offset amount may be determined based on the surcharge fraction. The offset amount may correspond to a fractional portion of the transaction cost. The offset amount may correspond to a fractional portion of the purchase amount.

The fractional portion may be a product of a surcharge fraction (“SF”) and the transaction cost. An exemplary SF may be defined by 0≦SF≦1. For example, if the SF is 0.3, the fractional portion may be approximately ⅓ of the transaction cost. The SF may be determined based on a performance metric. The SF may be associated with a transaction attribute.

The fractional portion may be one. When the fractional portion is one, the surcharge may correspond to the entire transaction cost. The fractional portion may be zero. A fractional portion of zero may correspond to no imposition of a surcharge. When the fractional portion is one, the customer may bear the transaction cost. When the fractional portion is zero, the merchant may bear the transaction cost. When the fractional portion is between zero and one, the transaction cost may be shared by the merchant and customer.

The surcharge attribute may include a product type of the payment instrument. The product type may correspond to a “rewards card” or other suitable features of the payment instrument.

Exemplary surcharge attributes are listed below in Table 6.

TABLE 6
Illustrative Surcharge Attributes.
Illustrative Surcharge Attributes

Surcharge fraction
Total offset amount
Fixed fee amount
Payment instrument
Payment instrument product type
Merchant category code
Product stock keeping unit (“SKU”)
Transaction network
Issuer
Surcharge imposition start time
Surcharge imposition end time
Transaction location
Transaction time

The transaction record may include a plurality of surcharge attributes. When the transaction record includes a first surcharge attribute, the system may transmit a first cost to the merchant. When the transaction record includes a second surcharge attribute, the system may transmit a second cost to the merchant.

For example, the first surcharge attribute may indicate that the merchant will not impose a surcharge on a transaction. The first surcharge attribute may correspond to a surcharge fraction of zero. Because the merchant will not impose the surcharge, the system may associate the transaction record with the first cost. The second surcharge attribute may indicate that the merchant will impose the surcharge on the transaction. Because the merchant will impose the surcharge, the system may associate the transaction record with the second cost.

The second cost may be higher than the first cost. By offering a variety of cost options, the transaction precipitant may attempt to reduce a number of transactions that the merchant will associate with a surcharge.

Apparatus may include a system for dynamically controlling a transaction cost paid by a transaction participant. The system may include one or more non-transitory computer-readable media storing computer-executable instructions. The instructions, when executed by a processor on a computer system may dynamically control the transaction cost. The system may be operated by the transaction participant or a third party.

The system may identify a transaction cost that is associated with a transaction participant such as the merchant. The system may identify a transaction cost that is associated with a payment instrument.

For example, for specific payment instruments, the merchant may obtain a fee schedule from a transaction network. The fee schedule may delineate processing fees charged by the transaction network for processing transactions associated with the payment instrument. The system may identify the fee schedule and apply a transaction cost based on the fee schedule.

The identifying of the transaction cost may include identifying a default transaction cost. The default transaction cost may be associated with the merchant or any suitable transaction participant. The default transaction cost may be associated with the payment instrument.

For example, a transaction participant may set a default transaction cost for processing transactions that originate at the merchant and include a transaction attribute corresponding to a specific payment instrument. The transaction participant may set different default transaction costs for each of a plurality of payment instruments or other suitable transaction attributes.

The system may monitor a change in a surcharge imposed by the merchant. The surcharge imposed by the merchant may be associated with one or more transaction attributes. The merchant may change the offset amount associated with the surcharge. The merchant may change the offset amount based on one or more transaction attributes. The merchant may change one or more surcharge attributes.

For example, if the merchant operates a concession stand near a rail-road station, the merchant may raise the offset amount during peak travel times. The system may adjust the transaction cost based on a detected change in the surcharge. If the merchant raises the offset amount, the transaction cost charged to the merchant may be increased. If the merchant lowers the surcharge, the transaction cost charged to the merchant may be decreased. Any suitable transaction participant may increase or decrease a transaction cost charged for providing transaction services to the merchant.

The transaction participant may attempt to encourage the merchant to reduce or eliminate the surcharge. The transaction participant may encourage the merchant to change an imposed surcharge by offering lower or reduced fees for processing transactions associated with no or low surcharges.

Following the adjusting of the transaction cost, the system may charge the merchant the adjusted transaction cost. The system may charge the merchant the adjusted transaction cost for processing future transactions. The system may charge the merchant the adjusted transaction for processing past transactions.

For example, a transaction participant may charge a first fee if the merchant commits to imposing a surcharge less than a threshold amount. The transaction participant may stipulate with the merchant that if the merchant increases the surcharge above the threshold amount, the transaction cost for past transaction processing will be recalculated based on the fee associated with a surcharge above the threshold. Conversely, the transaction participant may stipulate that if the merchant maintains the surcharge below a threshold for the period of time, the transaction cost for processing past transactions will be reassessed based on an adjusted lower transaction cost. The merchant may receive a refund or rebate as a result of the reassessment.

The adjusting of the transaction cost may include increasing the transaction cost if the merchant increases the offset amount of a surcharge. The adjusting may include decreasing the transaction cost if the merchant decreases the offset amount of the surcharge.

For example, in response to an increase in the offset amount by the merchant, a transaction participant may transmit a notice to the merchant. The notice may inform another transaction participant that the transaction cost of services provided to the other transaction participant will increase above the default cost. The notice may inform the merchant, or other transaction participant, that if specific payment instruments are exempted from the increased surcharge, a future transaction cost for processing transactions may be reduced below the default rate.

When the transaction cost is increased in response to the merchant changing a surcharge attribute, the adjusting of the transaction cost may include decreasing the transaction cost when the merchant decreases the surcharge.

For example, a transaction processing network may implement a transaction processing fee schedule that increases the transaction cost if the merchant imposes a surcharge on a credit card transaction. The fee schedule may also require a reduction in the transaction cost if the merchant reduces or eliminates the surcharge. The required reduction may protect the merchant from being penalized with higher transaction costs even after the merchant reduces or eliminates the surcharge.

The system may, after adjusting the transaction cost and before charging the merchant the adjusted cost, transmit the transaction cost to the merchant. For example, the merchant may be provided an opportunity to review a potential adjustment in the transaction cost imposed by a transaction participant. The system may transmit options that may be exercised by the merchant to retain a default transaction cost. The system may transmit options that may be exercised to reduce the transaction cost below the default cost. The options may include adjusting one or more surcharge attributes.

When the change in the surcharge corresponds to an increase in the offset amount, the system may increase the transaction cost if the merchant maintains the increase for a time period. For example, the adjusting of the transaction cost may be delayed for a period of time following detecting of a change in the offset amount or other surcharge attribute. The period of time may provide a grace period before a change in the transaction cost is implemented by the transaction participant.

When the change in the surcharge corresponds to a decrease in the offset amount, if the merchant maintains the decrease for a time period, the system may decrease the transaction cost. For example, the transaction participant may only offer to decrease the transaction cost after the merchant demonstrates a commitment to a reduced offset amount. The merchant may demonstrate commitment by maintaining a surcharge reduction for a period of time. The merchant may demonstrate the commitment by maintaining a surcharge reduction for a number of transactions.

The system may include instructions for increasing the transaction cost in response to receiving a notification of an intent of the merchant to increase the surcharge. For example, the merchant may be required to inform one or more transaction participants of an intent to impose a surcharge on transactions. In response to receiving the notification of intent, the transaction participant may adjust the transaction cost associated with processing of transactions submitted by the merchant. The transaction participant may adjust the transaction cost upon receipt of the notification of intent. The transaction participant may adjust the cost based on a time at which the merchant plans to begin imposing the surcharge or implement a change in a surcharge attribute.

For example, the system may adjust the transaction cost during a notice time. The notice time may correspond to a period of time during which an intent to “turn on” the surcharge is communicated. The intent may be communicated to the customer, a transaction participant or any suitable party. The system may include instructions for decreasing the transaction cost in response to an intent of the merchant to decrease the surcharge.

The system may incrementally adjust the transaction cost. The transaction cost may be incrementally adjusted until a limit is reached. For example, if the merchant imposes a surcharge, the transaction cost for processing transactions affected by the surcharge may be increased by 0.005¢. If the merchant maintains the surcharge for a period of time, the transaction cost may be increased by 0.01¢. If the merchant implements an increase in the surcharge, the transaction cost may be increased by 0.05¢.

The system may increase the transaction cost in increments until a maximum limit is reached. The maximum limit may be set based on one or more government regulations that control payment instrument transactions. The maximum limit may be set at the discretion of a transaction network or any suitable transaction participant. The maximum limit may be set by an agreement between one or more transaction participants.

The system may include instructions for decreasing the transaction cost in increments. The transaction cost may be decreased in increments until a minimum limit is reached. The minimum limit may be set based on government regulations controlling payment instrument transactions. The minimum limit may be set at the discretion of the transaction network or any suitable transaction participant. The minimum limit may be set by an agreement between one or more transaction participants.

The system may include instructions for adjusting the transaction cost in equal sized increments. The system may include instructions for adjusting the transaction cost in unequal sized increments. The system may include instructions for adjusting the transaction cost based on a mathematical function. Exemplary mathematical functions may include linear functions, exponential functions, logarithmic functions, and sinusoidal functions.

In response to the change in a surcharge attribute, the adjusting of the transaction cost may include increasing the transaction cost by a first amount for a first volume of payment instrument transactions. The adjusting of the transaction cost may include increasing the transaction cost by a second amount for a second volume of transactions. The second amount may be greater than the first amount.

For example, if the merchant increases the surcharge, the transaction cost charged to the merchant for processing the next 100 k payment instrument transactions may be increased by 1%. The merchant may increase the surcharge by extending a time during which the surcharge is imposed. The merchant may increase the surcharge by increasing the offset amount. If the merchant maintains or raises the surcharge for the next 100 k transactions, the transaction cost charged to the merchant for processing the next 50 k transactions may be increased by 1.5%.

The transaction cost may be adjusted based on a change in a surcharge attribute. The surcharge attribute may be a time value associated with a surcharge. For example, the merchant may elect to impose a surcharge. If the merchant maintains the surcharge for a first threshold period of time, the transaction cost for processing transactions submitted by the merchant may be increased by a first amount. If the merchant maintains the surcharge for a second period, the transaction cost may be increased by a second amount. The second amount may be greater than the first amount.

The adjusting of the transaction cost may include determining a transaction cost tier. The transaction cost tier may be determined based on the change in a surcharge attribute. The transaction cost tier may correspond to a fee schedule for processing one or more transactions.

For example, a transaction participant may maintain multiple transaction cost tiers. Each transaction cost tier may include a different fee schedule for processing a transaction. Based on one or more merchant attributes, a merchant may qualify for one of the multiple transaction cost tiers. Changing a surcharge attribute may result in a change in the tier associated with the merchant.

In response to a decrease in the surcharge, the adjusting may include decreasing the transaction cost by a first amount for a first volume of transactions. The decrease in the surcharge may correspond to shortening a time during which the surcharge is imposed. The decrease in the surcharge may correspond to a decrease in the offset amount. In response to the decrease in the surcharge, the adjusting of the transaction cost may include decreasing the transaction cost by a second amount for a second volume of transactions. The second amount may be greater than the first amount. The merchant may be rewarded with a greater decrease in the transaction cost for maintaining the decrease in the surcharge.

The adjusting of the transaction cost may include decreasing the transaction cost below the default transaction cost when the change in the surcharge corresponds to an elimination of the surcharge. Elimination of the surcharge may correspond to setting the surcharge fraction equal to zero.

Apparatus may include an article of manufacture that includes a non-transitory computer usable medium having computer readable program code embodied therein. The computer readable code may determine a merchant discount rate associated with a payment instrument.

The article may associate a default transaction cost with a merchant or other suitable party. The default transaction cost may be associated with the payment instrument.

For example, an issuer may offer a variety of payment instrument products. Each product offered by the issuer may be associated with a transaction cost fee schedule. The article may include code for increasing the default transaction cost in response to the merchant associating the payment instrument with a surcharge.

The article may include code for increasing the default transaction cost for a period of time. The article may include code for increasing the default transaction cost based on a merchant category code (“MCC”) associated with a transaction.

For example, the merchant may change a time when the surcharge is in effect. Based on the change in time, a transaction network may increase the cost for processing transactions that are associated with at least one of the merchant's MCC designations.

The article may include code for increasing the default transaction cost based on a transaction attribute associated with a transaction. The transaction attribute may be a geographic location associated with the transaction. For example, the merchant may be located in a geographic region where customers are statistically more sensitive to a surcharge. The increased sensitivity may result in customers refraining from making a purchase if a surcharge is imposed. If the merchant increases the surcharge at a location within the geographic region, the transaction cost imposed on the merchant may be increased by a first amount.

If the merchant increases the surcharge at a location outside the geographic region, the transaction cost imposed on the merchant may be increased by a second amount. The first amount may be greater than the second amount. Raising the merchants transaction cost by the greater first amount may provide an incentive to the merchant to continue to accept the payment instrument without imposing surcharge on customers in the geographic region.

The article may include code for increasing the default transaction cost based on a monetary value of a transaction. For example, purchasers of “big ticket” items may be less sensitive to an imposition of a surcharge than purchasers of lower valued products. If the merchant imposes or increases the surcharge imposed on “big ticket” purchases, the transaction cost associated with those purchases may not be adjusted. If the merchant imposes or increases the surcharge on lower valued items, the transaction cost may be increased by an amount corresponding to the increase in the surcharge.

### Transaction Cost Brokering

Apparatus may include an electronic transaction routing platform. The platform may include one or more non-transitory computer-readable media storing computer-executable instructions. The instructions, when executed by a processor on a computer system may route transaction information. The instructions may be configured to route transaction in a manner inconsistent with the “Bypass Rule.”

The “Bypass Rule” requires that, for processing a transaction, a single transaction participant must be utilized to provide authorization services and settlement services. The electronic transaction routing platform may route transactions to a first transaction participant for authorization and a second transaction participant for settlement.

The platform may receive transaction information. The transaction information may include a transaction record. The transaction information may include a plurality of transaction records. The transaction information may include one or more transaction attributes. The transaction information may include one or more merchant attributes. The transaction information may include any suitable information.

The platform may route the transaction record to a first transaction network. The platform may receive, from the first transaction network, an authorization to charge an amount to an account associated with a payment instrument. The amount may be a purchase amount. The amount may include an offset amount. The authorization may be transmitted from the issuer associated with the payment instrument. Based on the authorization, the merchant may ship or release a product to the customer.

After receiving the authorization from the first transaction network, the platform may route the transaction information to a second transaction network. The merchant, the acquirer, transaction participant or any suitable party may receive settlement services from the second transaction network. Settlement services may include receiving funds corresponding to a settlement amount from the second transaction network. The settlement amount may correspond to a purchase price of the product. The settlement amount may include the offset amount imposed by the merchant. The settlement amount may correspond to an amount net any transaction costs.

The platform may route transaction information corresponding to a plurality of transactions. The transaction information may include a plurality of transaction records. The platform may receive a plurality of authorizations from the first transaction network. Each of the plurality of authorizations may correspond to one of the plurality of transactions or transaction records.

The platform may receive a plurality of settlement amounts from the second transaction network. Each of the plurality of settlement amounts may correspond to one of the plurality of transactions or transaction records. The plurality of transactions or records may each be associated a payment instrument.

For example, as payment for a purchase, the merchant may accept payment instruments associated with any one of four transaction networks. At a time of purchase, a customer may present a payment instrument associated with transaction network no. 4. A transaction record based on information extracted from the presented payment instrument may be routed to transaction network no. 2 for authorization. Transaction network no. 2 may transmit at least a portion of the transaction record to the issuer associated with the payment instrument. The issuer may transmit a response to transaction network no. 2. The response may include an approval or a denial of the transaction. Transaction network no. 2 may in turn transmit the authorization to the merchant or the acquirer. Transaction network no. 2 may transmit the authorization to the merchant/acquirer via transaction network no. 4.

After receiving the authorization, the merchant may ship or release the purchased product to the customer. After receiving the authorization, the merchant may submit at least a portion of the transaction record to transaction network no. 3 for settlement. Transaction network no. 3 may obtain funds from the issuer. Transaction network no. 3 and transfer the funds to an account of the merchant. The account of the merchant may be held at the acquirer. Transaction network no. 3 may transfer the funds directly to the acquirer. Transaction network no. 3 may transfer the funds to the merchant/acquirer via transaction network no. 4.

The transaction record may include a plurality of transaction attributes. The routing to the first transaction network may be based on one or more of the plurality of transaction attributes. The routing to the second transaction network may be based on one or more of the plurality of transaction attributes.

For example, the transaction record may include a transaction attribute corresponding to a monetary value of the transaction. Based on the value of the transaction, a particular transaction network may be selected to process the transaction. As a further example, the transaction record may be associated with a merchant location. Based on the merchant location contained in the transaction record, the transaction may be routed to a particular transaction network. The value of the transaction or the geographic location may impact the transaction cost charged by a transaction network for processing the transaction. The transaction cost may impact the routing of the transaction record.

The platform may route a portion of the transaction record to the first and/or second transaction networks based on a temporal value associated with the transaction record. For example, transaction records generated during morning hours may be routed for authorization to a first transaction network. Transaction records generated during afternoon hours may be routed to a second transaction network for authorization.

The platform may include instructions for adjusting a maximum recovery amount. The adjusting of the maximum surcharge amount may be based on a sum of: (1) a first transaction cost associated with transaction services provided by the first transaction network, and (2) a second transaction cost associated with transaction services provided by the second transaction network.

For example, a transaction network may set a maximum surcharge amount. The maximum surcharge amount may correspond to the largest offset amount that may be imposed by the merchant. The maximum surcharge amount may be expressed as a percentage of the purchase amount and/or transaction cost. The maximum surcharge amount may be expressed as a flat fee. The maximum surcharge amount may be expressed as a combination of the percentage and the flat fee.

The maximum recovery amount may correspond to the transaction cost charged to the merchant. The transaction cost may be charged to the merchant by one or more transaction processing networks for providing one or more transaction services. A transaction fee rule may forbid the merchant from charging the customer a surcharge that exceeds the transaction cost charged to the merchant. The transaction cost charged to the merchant may be dependent on which one of a plurality of transaction network is selected to process the transaction. For example, the transaction cost may include a transaction cost charged by a first transaction network to obtain an authorization for the transaction. The transaction cost may include a transaction cost charged by a second transaction network to settle the transaction.

Prior to incurring the charge for a transaction service, the merchant may be unaware of how much a transaction network may charge for providing the service. The maximum recovery amount may be expressed as a function of historical transaction costs incurred by the merchant for a particular transaction service. The maximum recovery amount may be expressed as a function of the transaction cost charged by a plurality of transaction networks to provide the particular transaction service. For example, the function may be a mean, median, standard deviation or any suitable function.

The platform may include instructions for transmitting a request for bids to provide one or more transaction services. The request may ask for a transaction cost that will be charged to process a threshold number of transactions. One or more transaction participants may transmit bids that include the transaction cost charged by the transaction participant to provide the transaction service. The transactions may be credit card transactions. The transactions may be debit card transactions. The transactions may be associated with any suitable payment instrument.

In response to the request, the platform may be configured to receive a plurality of bids. Each of the plurality of bids may identify a transaction cost for providing the requested transaction service. The requested transaction service may include processing the threshold number of transactions. For example, the cost may include (1) authorizing each transaction, and (2) settling each transaction.

Based on the received bids, the platform may select a transaction participant to provide the requested service. Based on the received bids, the platform may select a transaction participant to process the threshold number of transactions. The platform may route at least a portion of the threshold number of transactions to the selected transaction network for processing.

For example, a merchant may wish to obtain bids relating to how much a transaction network would charge to process 60 k transactions. Various transaction networks may submit bids via the platform indicating their transaction cost for processing the 60 k transactions. The platform may accept one or more of the submitted bids. Acceptance of a submitted bid by the platform may obligate the transaction participant to provide the requested transaction service. The platform may accept a bid on behalf of another transaction participant, such as a merchant or transaction broker. The transaction network may condition acceptance of a bid on advance payment of the total transaction costs due to process the 60 k transactions.

Upon acceptance of the bid, the accepting party may obtain a right to submit up to 60 k transaction to the transaction network and receive the requested transaction service at the transaction cost indicated in the accepted bid. The transaction service may be authorization and settlement services. The bid may specify any suitable transaction service.

Each of the threshold number of transactions may be associated with a monetary value. The monetary value may fall within a range. The range may include a low end. The range may include a high end. The low end and the high end differ by no more than one-hundred dollars.

For example, a transaction network may only be willing to submit bids to provide services for transactions that are associated with a monetary value between $100 and $200. For transactions that are associated with a monetary value falling within the range, the transaction network may offer to charge the merchant a special transaction cost. The special transaction cost may correspond to a transaction cost lower than the transaction cost charged to the merchant for processing transactions that fall outside the range. The special transaction cost may correspond to a transaction cost lower than the transaction cost charged to the merchant for processing a number of transactions less than the threshold number.

The threshold number of transactions may be associated with a geographic value. For example, a transaction network may offer to charge a merchant a special transaction cost for transactions that include an attribute corresponding to the geographic value. The geographic value may correspond to a geographic region. For example, the geographic value may be a longitude/latitude combination, a GPS marker, a zip code or any suitable value that designates a geographic region.

The transaction processing network may be willing to offer a special transaction cost to process a threshold number of transactions that include the geographic value. The geographic value may correspond to a geographic region that is associated with a low incidence of payment instrument fraud. The special transaction cost may correspond to a transaction cost lower than the transaction cost charged to a merchant for processing similar transactions that originate outside the geographic region.

The threshold number of transactions may be associated with a temporal value. The transaction record may include an attribute that corresponds to the temporal value. The temporal value may correspond to a time period. For example, the temporal value may include a start time, such as the first Monday in May. The temporal value may include an end time such as the second Tuesday in July. The transaction network may offer special pricing for processing the threshold number of transactions during the time period. The special pricing may provide an incentive to the merchant to route the threshold number of transactions to the transaction network for processing within the time period.

As a further example, the platform may be configured to receive bids to process transactions initiated on a Sunday, a “game day,” or around the area of a stadium or other entertainment arena. The platform may be configured to receive bids for transaction initiated during certain hours of a day.

The platform may receive a first portion of the threshold number of transactions from a first merchant. The platform may receive a second portion of the threshold number of transactions from a second merchant. The platform may transmit the first portion and the second portion to the selected transaction network.

The platform may function as an automated transaction broker of transaction processing services. For example, the platform may be configured to accept a bid that requires submission of a threshold number of transactions to a transaction network for processing. The platform may be configured to fulfill the submission requirement by gathering transactions that require processing from a plurality of merchants. Each of the plurality of merchants may submit, to the platform, a portion of the threshold number of transactions that the platform must submit to the transaction network.

The platform may charge each merchant the transaction cost specified in the accepted bid for processing each transaction submitted to the transaction network for processing. In some embodiments, the platform may direct each of the plurality of merchants to submit the transactions directly to the transaction network. The platform may communicate with acquirers associated with each of the plurality of merchants. The platform may function as the acquirer for the plurality of merchants.

The threshold number of transactions may be a first threshold number of transactions. When the threshold number of transactions is a first threshold number, the platform may transmit a transaction cost option to the transaction network. The option may set the transaction cost for processing a second threshold number of transactions.

An option may be transmitted from the transaction network. The option may be transmitted to the transaction network. The option may include an offer by the transaction participant that submitted the bid to provide additional transaction services. The additional transaction services may be the requested service. The additional transaction services may be different than the requested service.

For example, a transaction network may submit a bid to process a first threshold number of 100 k transactions at a transaction cost of 1.67% of the purchase amount. The purchase amount may differ for each of the 100 k transactions. The bid may include an option to process a second threshold number of 200K transactions at 1.60% of the purchase amount of each of the 200 k transactions.

The option may include a transaction cost that is greater than the transaction cost associated with the first threshold number of transactions. The option may include a transaction cost that is less than the transaction cost associated with the first threshold number of transactions. The option may include a transaction cost that is within a range of the transaction cost associated with the first batch of transactions.

The option may be associated with a period of time. The option may only be exercised within the period of time. The option may be exercised by the transaction network. The option may be exercised by the merchant. The option may be exercised by the electronic platform. The options may be exercised by any suitable transaction participant.

The option may be fully alienable. The option may be salable on a third party market. For example, a broker may purchase an option on behalf of a merchant, acquirer or a group of transaction participants. The broker may resell the option to other transaction participants that require transaction services. The broker may exercise the option and supply the required number of transactions to the selected transaction network. The broker may supply the required number of transactions from a plurality of transaction participants.

The platform may be configured to receive a plurality of transaction cost estimates from a plurality of transaction processing networks. The platform may identify one of the plurality of transaction cost estimates. The platform may transmit a transaction record to the transaction network associated with the identified estimate.

The platform may identify one of the plurality of transaction cost estimates. The identified transaction cost estimate may correspond to the transaction cost that is the lowest cost estimate of the plurality of transaction cost estimates.

A transaction processing network may include, in a submitted estimate, an assurance that a transaction service will be provided within a specified time frame. For example, the estimate may specify that settlement of a transaction will occur within 48 hours from a time the transaction is presented to the transaction network for processing. The platform may be configured to accept entered criteria for identifying and/or accepting an estimate.

The platform may identify one of the plurality of transaction cost estimates based on a settlement time associated with the estimate.

The platform may transmit the transaction record to a first transaction network for authorization. The platform may transmit the transaction record to a second transaction network for settlement. The platform may transmit the transaction record to a single transaction network for authorization and settlement.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

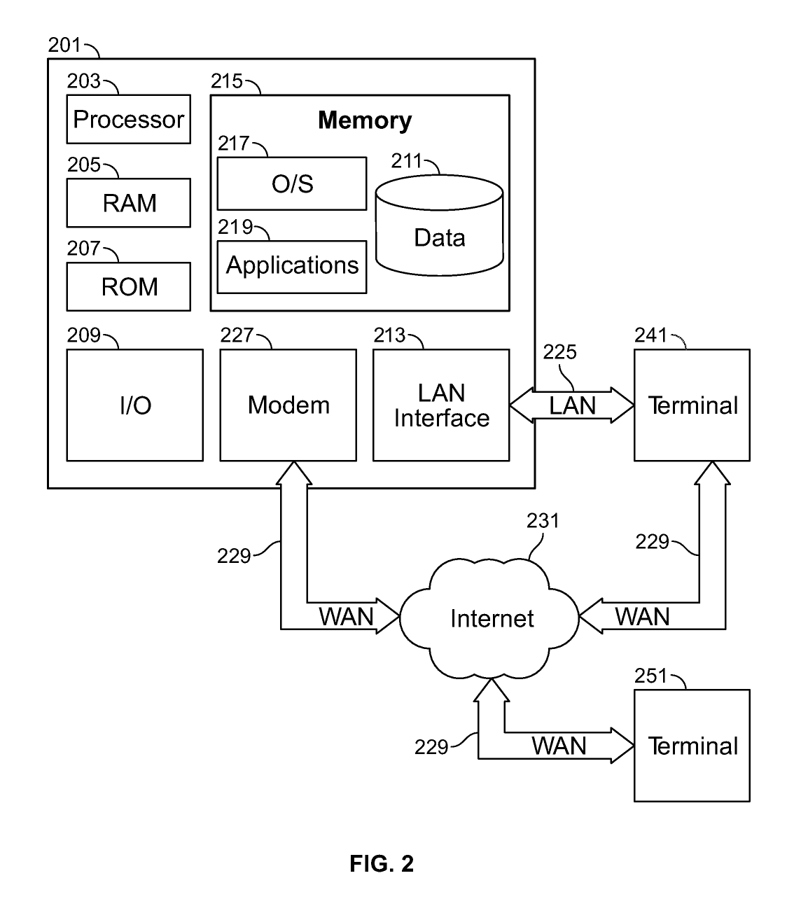

FIG. 2 is a block diagram that illustrates a generic computing device 201 (alternatively referred to herein as a “server”) that may be used according to an illustrative embodiment of the invention. The computer server 201 may have a processor 203 for controlling overall operation of the server and its associated components, including RAM 205, ROM 207, input/output module 209, and memory 215. Server 201 may include one or more receiver modules, server modules and processors that may be configured to receive transaction information, receive transaction rules, receive transaction participant information, receive transaction service provider information, apply transaction routing rules, generate transaction information, compare values and perform any other suitable tasks related to determining the transaction cost.

Input/output (“I/O”) module 209 may include a microphone, keypad, touch screen, and/or stylus through which a user of device 201 may provide input, and may also include one or more of a speaker for providing audio output and a video display device for providing textual, audiovisual and/or graphical output. Software may be stored within memory 215 and/or storage to provide instructions to processor 203 for enabling server 201 to perform various functions. For example, memory 215 may store software used by server 201, such as an operating system 217, application programs 219, and an associated database 211. Alternatively, some or all of server 201 computer executable instructions may be embodied in hardware or firmware (not shown). As described in detail below, database 211 may provide storage for customer information, transaction cost information, performance metrics quantities, thresholds, transaction information, merchant information, transaction fee rules, biometric features, payment instrument information associated with a biometric feature and any other suitable information.

Server 201 may operate in a networked environment supporting connections to one or more remote computers, such as terminals 241 and 251. Terminals 241 and 251 may be personal computers or servers that include many or all of the elements described above relative to server 201. The network connections depicted in FIG. 2 include a local area network (LAN) 225 and a wide area network (WAN) 229, but may also include other networks. When used in a LAN networking environment, computer 201 is connected to LAN 225 through a network interface or adapter 213. When used in a WAN networking environment, server 201 may include a modem 227 or other means for establishing communications over WAN 229, such as Internet 231. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 219, which may be used by server 201, may include computer executable instructions for invoking user functionality related to communication, such as email, short message service (“SMS”), and voice input and speech recognition applications.

Computing device 201 and/or terminals 241 or 251 may also be mobile terminals including various other components, such as a battery, speaker, and antennas (not shown).

Terminal 251 and/or terminal 241 may be portable devices such as a laptop, smart phone, tablet, or any other suitable device for storing, transmitting and/or transporting relevant information.

Any information described above in connection with database 211, and any other suitable information, may be stored in memory 215.

One or more of applications 219 may include one or more algorithms that may be used to receive transaction information, route transaction records, receive transaction participant information, receive transaction service provider information, apply transaction cost rules, generate transaction information and perform any other suitable tasks related to determining a transaction cost.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, tablets, programmable consumer electronics, network PCs, minicomputers, mainframe computers, distributed computing environments that include any of the above systems or devices, and the like. In a distributed computing environment, devices that perform the same or similar function may be viewed as being part of a “module” even if the devices are separate (whether local or remote) from each other.

The invention may be described in the general context of computer-executable instructions, such as program modules, being executed by a computer. Generally, program modules may include routines, programs, objects, components, data structures, etc., that perform particular tasks or store or process data structures, objects and other data types. The invention may also be practiced in distributed computing environments where tasks are performed by separate (local or remote) processing devices that are linked through a communications network. In a distributed computing environment, program modules may be located in both local and remote computer storage media including memory storage devices.

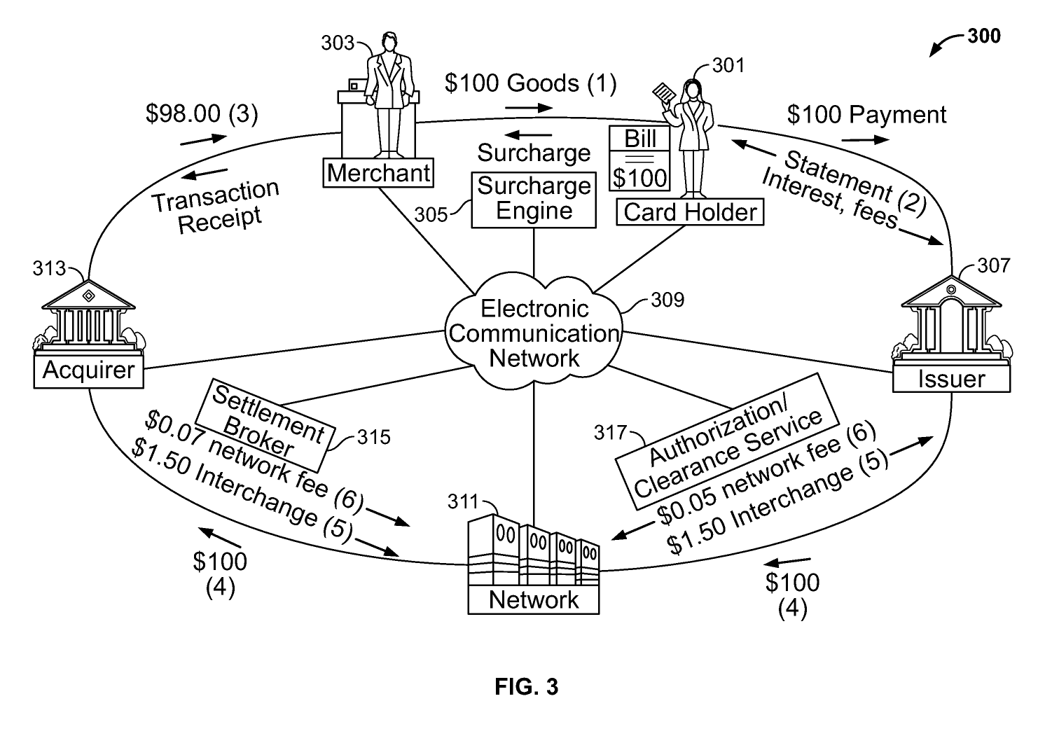

FIG. 3 shows illustrative credit card transaction settlement flow 300.

At step 1 card holder 301 may offer a payment instrument, such as a credit card, as payment for $100 of goods sold by merchant 303. Card holder 301 may present information associated with the credit card at the merchant's point-of-sale terminal (not shown). The information may be presented via the payment instrument, a loyalty card or any other suitable device or method.

Based on the information presented by card holder 301, surcharge engine 305 may determine an offset amount. The surcharge engine may determine one or more surcharge attributes. The offset amount may be based on the surcharge fraction.

The offset amount may be added to the $100 price charged by merchant 303. The $100 price may include the offset amount. A total amount may be determined. The total amount may include the price, offset amount, sales tax and any other suitable costs associated with the purchase of the goods.

The information presented by card holder 301, may be transmitted via electronic communication network 309 to transaction network 311. The information may include a transaction record.

Transaction network 311 may receive the information presented by card holder 301 via electronic network 309. Based on the received information, transaction network 311 may transmit an authorization, via electronic communication network 309, to merchant 303. Transaction network 311 may verify that card holder 301 has not exceeded a credit limit associated with the payment instrument. The authorization may include an indication that the transaction network has approved a charge of the total amount to an account associated with the payment instrument.

Card holder 301 may acknowledge the total amount. The acknowledgement may include an agreement by card holder 301 to place the charge on the account associated with the payment instrument. The acknowledgement may include a commitment by the card holder to pay the total amount to issuer 307.

At step 2, issuer 307 may prepare a statement for card holder 301. The statement may include the total amount owed to issuer 307. The statement may include interest or other fees owed to issuer 307. Issuer 307 may bear an expense of collecting the total amount, interest and fees from card holder 301. A portion of the transaction cost may flow to issuer 307 to fund collection efforts of issuer 307 and offset a risk of default of card holder 301.

At step 3, merchant 303 may present the acknowledgment of card holder 301 and/or the associated authorization by transaction network 311 to acquirer 313. Acquirer 313 may transfer funds to merchant 303 prior to actual collection, by issuer 307, of the total amount from card holder 301. Acquirer 313 may offer funds to merchant 303 prior to settlement between acquirer 313 and issuer 307.

Acquirer 313 may deduct a merchant discount from an amount of funds transferred to merchant 303. The offset amount determined by surcharge engine 305 may offset, at least in part, the merchant discount paid by merchant 303. The offset amount may be limited to transaction costs charged by transaction network 311. The offset amount may include transaction costs charged by acquirer 313 and issuer 307.

In flow 300, the merchant discount is 2% of the $100 price. Without an offset, merchant 303 receives $98 of the $100 price.

At step 4, acquirer 313 settles the transaction with issuer 307. Acquirer 313 may utilize transaction network 311 to settle the transaction. Acquirer 313 may utilize broker 315 to settle the transaction. Broker 315 may offer settlement services at a lower transaction cost than transaction network 311. Broker 315 may offer the lower transaction costs as a result of aggregating transactions from different acquirers. Each of the aggregated transactions may require settlement between issuer 307 and acquirer 313.

Step 4 shows that at least a portion of the merchant discount flows through transaction network 311 from acquirer 313 to issuer 307. Step 4 also shows that transaction network 311 may receive a network fee from acquirer 313. Step 4 also shows that transaction network 311 receives a network fee from issuer 307. Acquirer 313 and issuer 307 may pay transaction network 311 network fees for facilitating settlement of the transaction.

Table 7 shows net positions of the parties to flow 300.

TABLE 7
Net positions.

| Party | Net ($) |
|---|---|
| Issuer | 1.45 |
| Acquirer | 0.43 |
| Network | 0.12 |
| Merchant | 0 |
| Customer | −2.00 |

Table 8 shows benefits of flow 300 to the transaction participants.

TABLE 8
Illustrative benefits of each transaction participant.

| Party | Benefit |
|---|---|
| Merchant | Access to card holder funds and |
| | credit |
| | Timely settlement |
| | Protection from customer fraud |
| | and credit risk |
| | Increased purchase price |
| | amounts |
| | Payment guaranteed |
| Issuer | Reliable payment platform with |
| | broad acceptance |
| | Consistent customer experience |
| | across merchants |
| | Predictable source of revenue |
| | to support card issuance costs |
| Card holder | Access to ready funds and |
| | credit |
| | Ability to make purchases |
| | virtually anywhere |
| | Protection from fraud |
| | Protection from merchant |
| | disputes |
| | Reward for card based purchases |
| | Does not need to carry cash |
| Transaction Broker | Revenue from trading |
| | transaction processing bids |
| | Reliable routing platform |
| | Reducing transaction processing |
| | overhead |
| | Access to consumers and |
| | suppliers of transaction |
| | services |

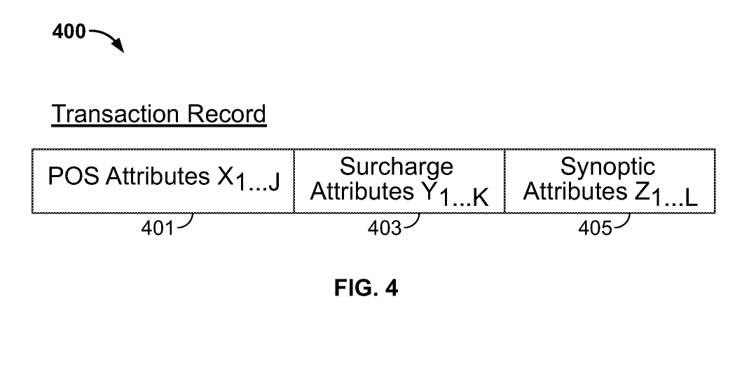

FIG. 4 shows illustrative transaction record 400. Transaction record 400 may be generated based on transaction information received and/or available at a time of purchase. The transaction record may include point of sale (“POS”) attributes 401. POS attributes 401 may include transaction information, customer information and merchant information. Exemplary POS attributes 401 may include a date, a time, a check-out lane indicator or any suitable transaction attribute available at a point-of-sale.

Transaction record 400 may include surcharge attributes 403. Exemplary surcharge attributes 403 may include an offset amount, maximum recovery amount, surcharge fraction, transaction cost or other suitable surcharge information.

Transaction record 400 may include synoptic attributes 405. Synoptic attributes 405 may include attributes derived by a system. Exemplary derived attributes may include a merchant transaction statistic, a market synoptic attribute statistic and an issuer synoptic statistic. Based on a statistical pattern, synoptic attributes 405 may be concatenated to transaction record 400. Synoptic attributes 405 may be concatenated to transaction record 400 after execution of the transaction.

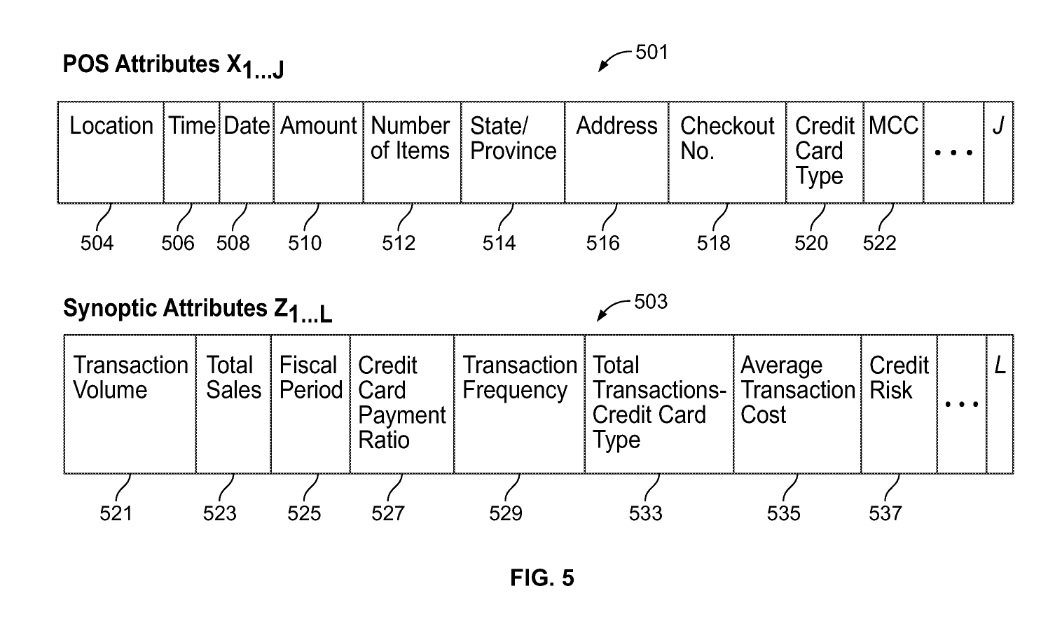

FIG. 5 shows illustrative POS attributes 501 and illustrative synoptic attributes 503. POS attributes 501 may include location 504. Location 504 may be associated with a POS terminal. Location 504 may be associated with an address. POS attributes 501 may include time 506 and date 508. POS attributes 501 may include amount 510 and number of items 512. Amount 510 may correspond to a price of the product. Number of items 512 may correspond to a number of items purchased by a customer in a transaction.

POS attributes 501 may include state/province 514. State/province 514 may be associated with regulations governing imposition of a surcharge.

POS attributes 501 may include checkout number 518. A merchant may impose a different offset amount at different check-out lines. The merchant may offer no or a reduced surcharge if a self-checkout line is utilized. The self-checkout line may be associated with a checkout number 518.

POS attributes 501 may include credit card type 520. Credit card type 520 may correspond to the payment instrument presented by a customer to pay for a purchase. A surcharge schedule or amount may be associated with credit card type 520.

POS attributes 501 may include merchant category code (“MCC”) 522. MCC 522 may group merchants that supply similar products. Some merchants in MCC 522 may impose a surcharge, while others may not. Merchants within MCC 522 may surcharge at different rates or amounts.

FIG. 5 includes synoptic attributes 503. Synoptic attributes 503 may include transaction volume 521, total sales 523 and fiscal period 525. Transaction volume 521 and total sales 523 may be associated with fiscal period 525.

For example, transaction records may be sorted by date 508 and location 504. A first number of transaction records may include the month of September and an address on Main Street. The first number may be appended to each transaction record that includes the date in September and the address on Main Street. The first number may correspond to transaction volume 521. The first number may be a synoptic attribute. A second number of transaction records may include a date in the month of August and the address on Main Street. The second number may be a synoptic attribute.

The first number may be compared to the second number. A result of the comparing may be a synoptic attribute. The first number may be concatenated to transaction records that include the date in September. The second number may be concatenated to transaction records that include the date in August. A result of the comparing may be concatenated to transaction records that include either the date in August or the date in September.

Synoptic attributes 503 may include credit card payment ratio 527. Credit card payment ratio 527 may include a comparison of a number of purchases made using a credit card compared to a number of purchases made using alternative payment methods. The ratio may be computed for a particular merchant, MCC, time/date, location credit card type or other suitable transaction attribute.

Synoptic attributes 503 may include transaction frequency 529, total transactions per credit card type 533 and average transaction cost 535. Average transaction cost 535 may be calculated for a plurality of transaction records.

For example, each transaction record that includes a particular POS attribute, such as a purchase made at location X, may include a variable transaction cost Y. Transaction cost Y may vary based on transaction attributes present in a transaction record. The transaction cost Y may correspond to a surcharge attribute (shown in FIG. 4, item 403). Average transaction cost 535 may correspond to an average transaction cost associated with location X. Average transaction cost 535 may be appended to each transaction record that includes the attribute corresponding to location X.

Synoptic attributes 503 may include credit risk 537. An issuer may associate each authorized transaction with a credit risk. The issuer may append the credit risk to the transaction record.

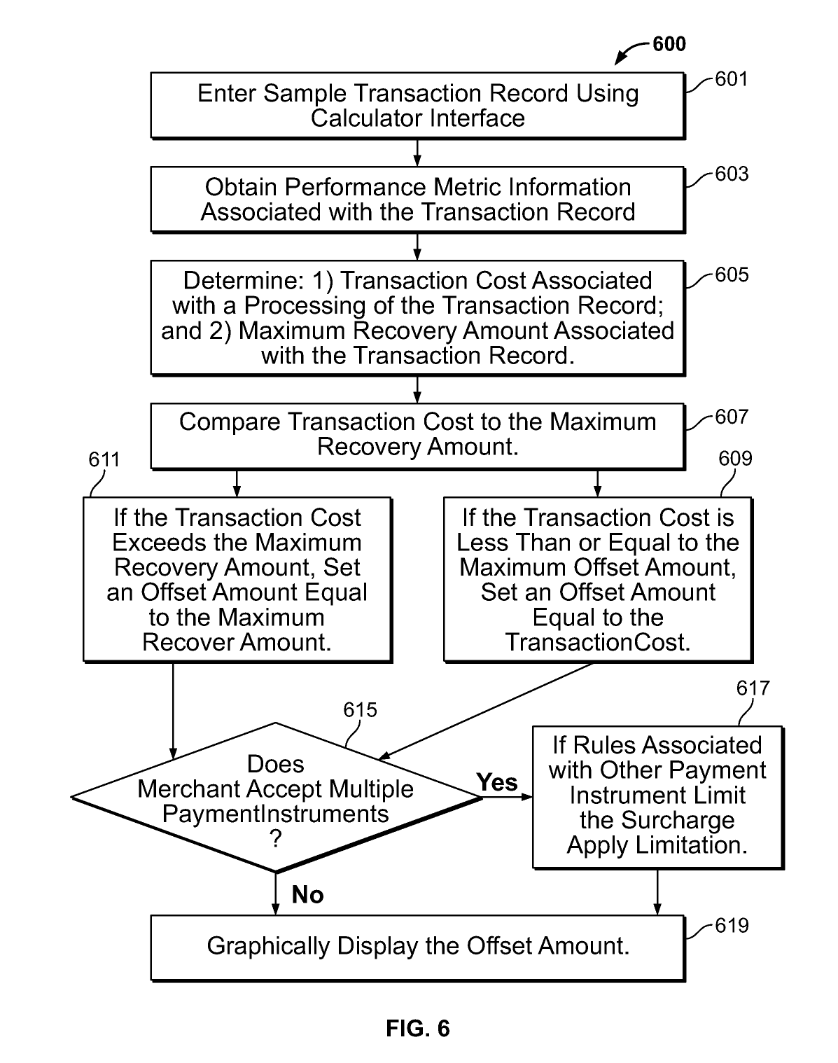

FIG. 6 shows illustrative process 600. Process 600 begins at step 601. At step 601, a user enters transaction information using an interface of a compliance calculator. The interface may be a graphical user interface (“GUI”). At step 603, the calculator obtains performance metric information associated with the entered transaction information. The performance metric information may include performance metric quantities. At step 605, the calculator determines a transaction cost for providing a transaction service. The transaction cost may be based on, at least a part of, the transaction information. At step 607, a maximum recovery amount is determined. The maximum recovery amount may correspond to a maximum recovery amount that the transaction network providing the transaction service may allow any merchant to impose on a customer.

At steps 611 and 609, the calculator sets an offset amount equal to the lessor of the transaction cost or the maximum recovery amount. The offset amount may correspond to a maximum surcharge that may be imposed on the customer for a given transaction cost.

At step 615, the calculator determines whether the transaction information includes an indication that the merchant accepts one or more payment instruments associated with a second transaction network. At step 617, if the merchant does accept one or more payments instrument associated with a second transaction network, the calculator determines if one or more rules set by the second transaction network require that the offset amount be adjusted.

At step 619, the calculator graphically displays the offset amount. The displayed offset amount may be the maximum offset amount that may be recovered from the customer. The offset amount may be recovered from the customer by adding a surcharge to a purchase amount charged to the customer at a time of purchase. The merchant may elect to charge the customer an amount less than the displayed offset amount.

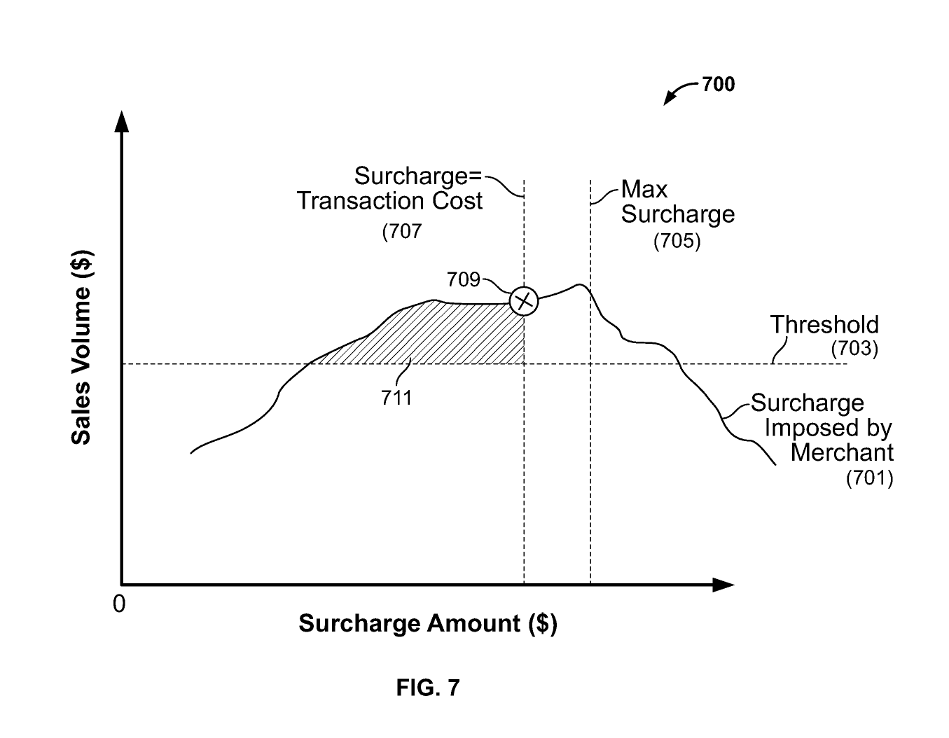

FIG. 7 shows illustrative relationship 700 between a surcharge amount and a sales volume. Relationship 700 may be determined for each payment instrument accepted by a merchant.

Function 701 shows that as the surcharge imposed by the merchant increases above max surcharge 705, the sales volume sharply decreases. Function 707 shows a surcharge amount that is equal to the transaction cost. The transaction cost is paid by the merchant to obtain transaction services. Function 703 corresponds to threshold sale volumes. The merchant may desire that sales volume remain above the threshold despite imposition of a surcharge.

Based on relationship 700, the merchant may determine a surcharge amount or a range of surcharge amounts that may be applied to a transaction. For example, based on relationship 700, any surcharge amount that corresponds to shaded area 711 bounded by functions 703 and 707 may be applied by the merchant. A surcharge amount that corresponds to the shaded area is equal to or less than the transaction cost and is associated with a sales volume above threshold 703.

The merchant may not be allowed to impose a surcharge amount that is greater than the transaction cost and less than the maximum surcharge. The merchant may be restricted by a transaction network from imposing a surcharge amount that is greater than the transaction cost. The merchant may impose surcharge amount 709. Surcharge amount 709 is equal to the transaction cost.

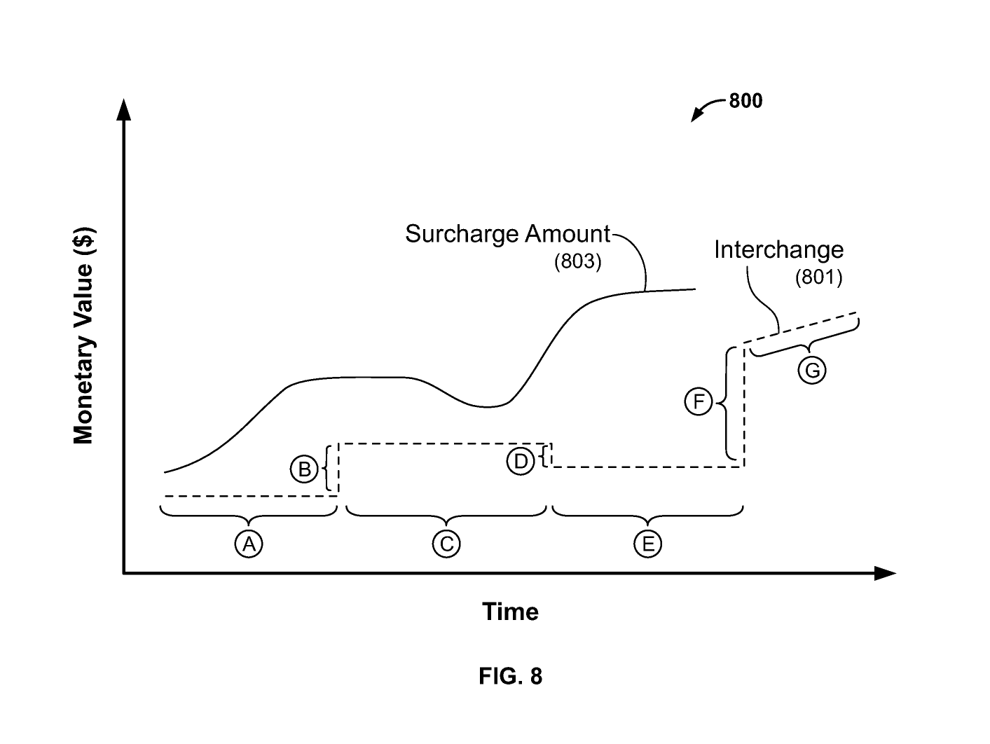

FIG. 8 shows illustrative relationship 800 between time and monetary value. The monetary value may correspond to surcharge amount 803. The monetary value may correspond to interchange fee 801.

Relationship 800 shows how an exemplary merchant may adjust the surcharge amount over time. At a particular time, the merchant may increase the surcharge amount. At a particular time the merchant may decrease the surcharge amount.

Relationship 800 shows how the interchange fee may be adjusted in response to a change in the surcharge amount. Region A shows that an adjustment to the interchange may lag behind an adjustment to the surcharge. Region B shows that the interchange may be increased in response to an increase in the surcharge. Region C shows that if the surcharge is maintained at a relatively constant monetary value, the interchange may be maintained at a constant monetary value.

Region D shows that if the merchant decreases the surcharge, the interchange fee may be decreased. Region E shows that an adjustment to the interchange may lag behind an adjustment to the surcharge. The lag time may provide an opportunity for a transaction participant to inform the merchant that the interchange fee may be adjusted in response to the adjustment in the surcharge. The lag time may provide the merchant an opportunity to readjust the surcharge.

Region F shows that shows that the interchange fee may be increased in response to an increase in the surcharge. Region G shows that once the surcharge is increased beyond a threshold monetary value, if the surcharge is maintained above the threshold monetary value, the interchange may be incrementally increased.

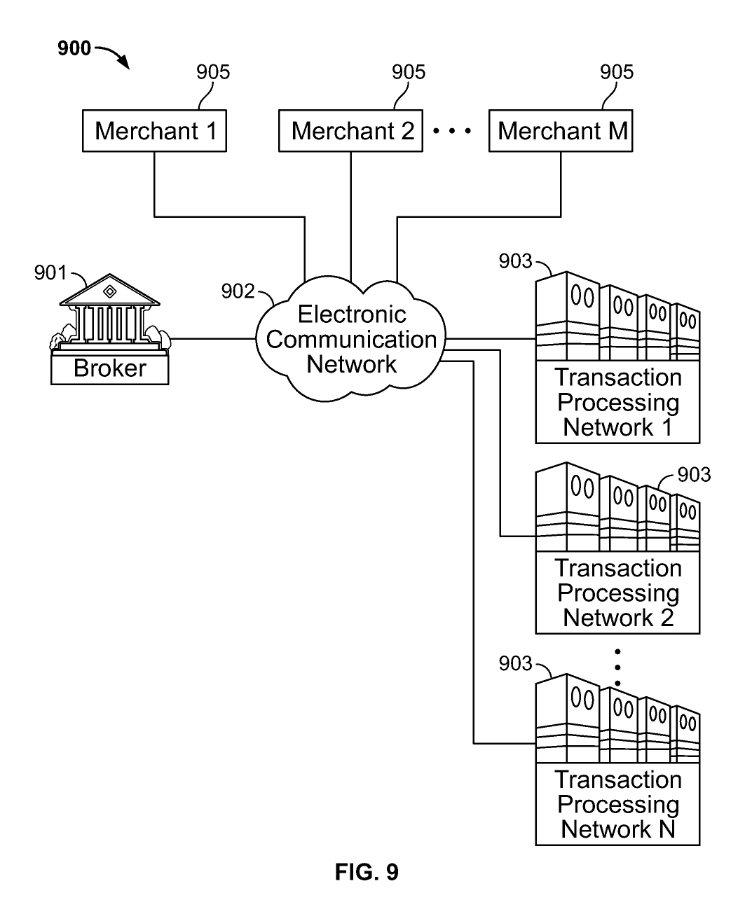

FIG. 9 shows illustrative network 900. Network 900 may include transaction broker 901, electronic communication network 902, transaction processing networks 903 and merchants 905. Broker 901 may offer transaction services to merchants 905. Broker 901 may offer transaction services to transaction processing networks 903. Transaction processing networks 903 may provide transaction services. Broker 903 may accept bids submitted by transaction networks 903. The bids may include offers to provide transaction services. Broker 903 may resell the transaction services offered by networks 903 to merchants 905.

For example, transaction processing network 1 may provide authorization services. Transaction processing network 2 may provide settlement services. Broker 901 may “bundle” transaction services provided by different transaction processing networks. Broker 901 may offer the bundled services to merchants 905. The bundled services may include both authorization and settlement services. Broker 901 may instruct merchant 1 to transmit “X” number of transactions to transaction processing network 1 for authorization. Broker may instruct merchant 2 to transmit “Y” number of transactions to transaction processing network 2 for settlement.

Electronic communication network 902 may be operated by broker 901. Electronic communication network 901 may be configured to select one of the transaction networks 903 that offers the lowest transaction cost to process the transactions conducted by merchants 905. Electronic communication network 902 may be configured to select one or more of transaction networks 903 to process transactions based on any suitable criteria. Exemplary criteria may include the transaction network associated with the payment instrument, the issuer associated with the transaction, a volume of transactions, a value of the transactions a risk associated with the transactions or a transaction attribute.

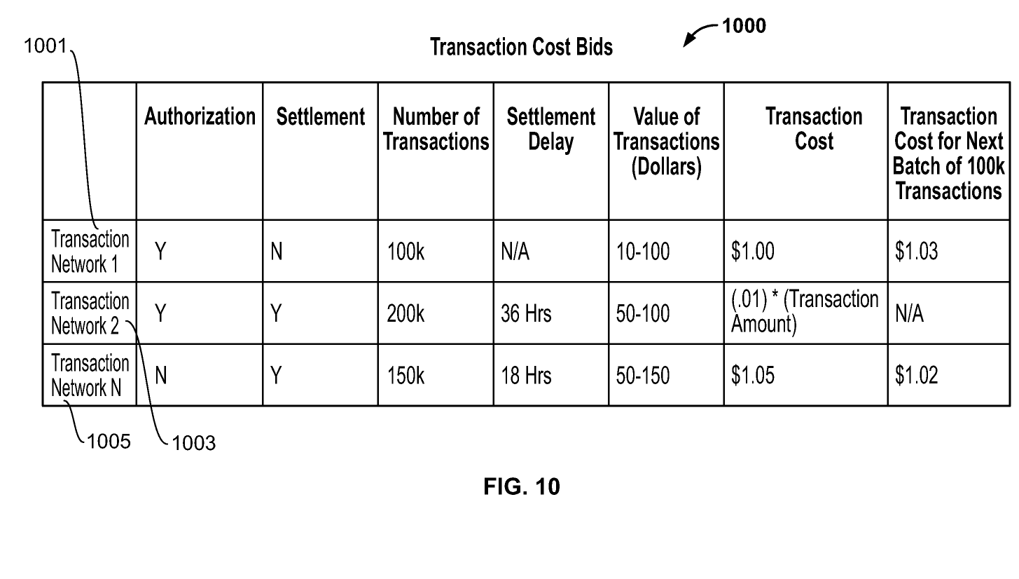

FIG. 10 shows illustrative information 1000. Information 1000 includes transaction cost bids 1001, 1003 and 1005.

Exemplary bid 1001 shows that transaction network 1 is offering authorization service for 100 k transactions. Bid 1001 indicates that transaction network 1 will only process transactions that are associated with a transaction amount between $10 and $100. Bid 1001 also indicates that transaction network 1 is offering to authorize 100 k transactions for a flat fee of $1 per transaction. Bid 1001 includes an option for authorizing another 100 k of transactions. The option offers to authorize another 100 k transaction for a flat fee of $1.03 per transaction.

Exemplary bid 1003 shows that transaction network 2 is offering authorization and settlement services for 200 k transactions. Bid 1003 is associated with an assurance that settlement will occur within 36 hours. Bid 1003 indicates that transaction network 2 will only process transactions that are associated with a transaction amount between $50 and $100. Bid 1003 also indicates that transaction network 2 is offering to process 200 k transactions for a variable fee of (0.01)*(Transaction Amount) for each transaction. Bid 1003 does not include an option for processing an additional batch of transactions.

Exemplary bid 1005 shows that transaction network 3 is offering settlement service for 150 k transactions. Bid 1005 indicates that transaction network 3 will only process transactions that are associated with a transaction amount between $50 and $150. Bid 1005 also indicates that transaction network 3 is offering to settle 150 k transactions for a flat fee of $1.05 per transaction. Bid 1005 also includes an option for settling another 100 k of transactions. The option offers to authorize another 100 k transaction for a flat fee of $1.02 per transaction.

The fee associated with bids 1001, 1003 and 1005 may include any and all costs charged by transaction participants. The fee may correspond to a transaction cost. For example, the fee may include a network fee, an interchange fee and any acquirer fees. Bids 1001, 1003 and 1005 may be accepted by a broker, such as broker 315 (shown in FIG. 3). Bids 1001, 1003 and 1005 may be accepted by a merchant such as merchant 303 (shown in FIG. 3). The bids may be associated with an expiration time. The bids may not be accepted by any party after the expiration time. The options may be associated with an expiration time. The options may not be accepted by any party after the expiration time.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for determining a transaction cost in connection with a processing of a transaction have been provided. Persons skilled in the art will appreciate that the present invention can be practiced by other than the described embodiments, which are presented for purposes of illustration rather than of limitation. The present invention is limited only by the claims that follow.

What is claimed is:

1. A system for determining a cost of accepting a payment instrument, the system comprising one or more computer-readable media storing computer-executable instructions which, when executed by a processor on a computer system determine the cost, the instructions comprising instructions for:
receiving a request from a merchant for a cost-quote, the request comprising a transaction record;
when the transaction record comprises a first surcharge attribute, transmitting to the merchant a first cost; and
when the transaction record comprises a second surcharge attribute, transmitting to the merchant a second cost;
wherein:
the first cost corresponds to a cost associated with a merchant that does not impose a surcharge; and
the second cost corresponds to a cost associated with a merchant that does impose the surcharge.

2. A system for dynamically adjusting a transaction cost paid by a merchant, the system comprising one or more computer-readable media storing computer-executable instructions which, when executed by a processor on a computer system dynamically adjust the transaction cost, the instructions comprising instructions for:
identifying the transaction cost associated with:
the merchant; and
a payment instrument;
monitoring a change in a surcharge imposed by the merchant on a transaction associated with the payment instrument;
adjusting the transaction cost based on the change in the surcharge; and
following the adjusting, charging the merchant the transaction cost.

3. The system of claim 2 wherein the identifying comprises identifying a default transaction cost associated with:
the merchant; and
the payment instrument.

4. The system of 2 further comprising instructions for, after the adjusting and before the charging, transmitting the transaction cost to the merchant.

5. The system of claim 2 wherein the adjusting comprises:
increasing the transaction cost if the merchant increases the surcharge; and
decreasing the transaction cost if the merchant decreases the surcharge.

6. The system of claim 2 wherein, when the increasing of the transaction cost is in response to the merchant increasing the surcharge, the adjusting comprises decreasing the transaction cost if the merchant decreases the surcharge.

7. The system of claim 2 wherein, when the change in the surcharge corresponds to an increase in the surcharge, if the merchant maintains the increase for a time period, increasing the transaction cost.

8. The system of claim 2 wherein, when the change in the surcharge corresponds to a decrease in the surcharge, if the merchant maintains the decrease for a time period, decreasing the transaction cost.

9. The system of claim 2 further comprising instructions for increasing the transaction cost in response to receiving an intent of the merchant to increase the surcharge.

10. The system of claim 9 further comprising instructions for adjusting the transaction cost during a notice time.

11. The system of claim 2 further comprising instructions for decreasing the transaction cost in response to receiving an intent of the merchant to decrease the surcharge.

12. The system of claim 2 further comprising instructions for incrementally adjusting the transaction cost until a limit is reached.

13. The system of claim 12 further comprising instructions for:
when the change in the surcharge corresponds to an increase in the surcharge, increasing the transaction cost in increments until a maximum limit is reached; and
when the change in the surcharge corresponds to an decrease in the surcharge, decreasing the transaction cost in increments until a minimum limit is reached.

14. The system of claim 13 further comprising instructions for adjusting the transaction cost in equal sized increments.

15. The system of claim 13 further comprising instructions for adjusting the transaction cost in unequal sized increments.

16. The system of claim 2 wherein the adjusting comprises determining a transaction cost tier based on the change in the surcharge.

17. The system of claim 2 wherein the adjusting comprises, in response to an increase in the surcharge:
for a first volume of transactions associated with the payment instrument, increasing the transaction cost by a first amount; and
for a second volume of transactions associated with the payment instrument, increasing the transaction cost by a second amount;
wherein the second amount is greater than the first amount.

18. The system of claim 2 wherein the adjusting comprises, in response to a decrease in the surcharge:
for a first volume of transactions associated with the payment instrument, decreasing the transaction cost by a first amount; and
for a second volume of transactions associated with the payment instrument, decreasing the transaction cost by a second amount;
wherein the second amount is greater than the first amount.

19. The system of claim 2, wherein, when the change in the surcharge corresponds to an elimination of the surcharge, the adjusting corresponds to decreasing the transaction cost below the default transaction cost.

20. An article of manufacture comprising a computer usable medium having computer readable program code embodied therein, the code, when executed by a processor, determines a merchant discount rate associated with a payment instrument, the code in said article of manufacture comprising:
computer readable program code for associating a default transaction cost with a merchant, the default transaction cost associated with a payment instrument;
computer readable program code for increasing the default transaction cost in response to the merchant associating the payment instrument with a surcharge.

21. The article of claim 20 further comprising computer readable code for increasing the default transaction cost for a period of time.

22. The article of claim 20 further comprising computer readable code for increasing the default transaction cost based on a merchant category code associated with a transaction.

23. The article of claim 20 further comprising computer readable code for increasing the default transaction cost based on a geographic location associated with a transaction.

24. The article of claim 20 further comprising computer readable code for increasing the default transaction cost based on a monetary value of a transaction.
